(19) United States
(12) Patent Application Publication
(10) Pub. No.: US 2017/0026414 A1
(43) Pub. Date: Jan. 26, 2017

(54) Methods Circuits Devices Systems and Functionally Associated Computer Executable Code for Managing a Data Access Network

(71) Applicant: SAGUNA NETWORKS LTD., Yokneam Illit (IL)

(72) Inventors: Daniel Nathan Frydman, Haifa (IL); Lior Fite, Zurit (IL)

(21) Appl. No.: 15/149,116

(22) Filed: May 7, 2016

Related U.S. Application Data
(60) Provisional application No. 62/158,000, filed on May 7, 2015.

(51) Int. Cl. H04L 29/06; H04L 29/08; G06F 21/62; H04L 12/66

(52) U.S. Cl. CPC H04L 63/20; H04L 12/66; H04L 67/2842; H04L 63/166; G06F 21/62; H04L 63/0428; H04L 67/42; H04L 45/22

(57) ABSTRACT

Disclosed are methods, circuits, devices, systems and functionally associated computer executable code for managing a data access network. There may be provided a data access network including one or more client access nodes and an internet gateway including a TLS proxy. A network performance boosting appliance may receive data extracted from encrypted communication sessions traversing the gateway in order to boost the data access network's performance.

### RELATED APPLICATIONS

The present invention claims priority from U.S. Provisional Patent Application No. 62/158,000 filed May 7, 2015 which is hereby incorporated by reference in its entirety.

### FIELD OF THE INVENTION

The present invention generally relates to the fields of communication and communication network operation. More specifically, the present invention relates to the use of Transport Layer Security (TLS) proxies, for example at a network's Gateway (GW) to the internet, to boost or improve network performance and/or service quality.

### BACKGROUND

In recent years, the use of Transport Layer Security (“TLS”) protocol over the Internet to deliver content is growing rapidly. Though the encryption associated with TLS is promoting better user privacy over open network connections and blocking eavesdropping, it is also blocking or hindering essential network functions from working properly. Such network functions hindered by the TLS may include: content caching, network analytics functions, network antivirus functions, parental control, etc.

Accordingly, there has developed a need in the field of data access network management for solutions that may enable network management functions to continue properly operating in a TLS environment while ensuring user privacy. There is a need to enable the exchange of sensitive information, like passwords or financial information, to remain in the encrypted TLS domain while allowing for less sensitive information, like video clips or images, to be exposed to network management appliances and functional blocks, for example by selectively extracting the less sensitive information from within the TLS encryption stream.

### SUMMARY OF THE INVENTION

According to embodiments of the present invention, there may be provided a Transport Layer Security (“TLS”) Proxy enabled Gateway (“GW”) functionally associated with a data access network and located between a data client device communicatively coupled to an access node of the data access network and a remote server communicatively coupled to the internet. The TLS Proxy enabled GW may be a transparent TLS&TCP Proxy towards the client device and nontransparent, or partially transparent, TLS&TCP Proxy towards the remote server. One or more issues in managing and/or boosting performance of the data access network, caused by the transport of TLS communication between network client devices and servers located in the Internet, may be mitigated and/or solved by utilizing a TLS proxy functionally associated with a network performance boosting appliance as disclosed herein.

The present invention includes methods, circuits, devices, systems and functionally associated computer executable code for managing a data access network. According to some embodiments, encrypted data exchanged between a data client application running on a mobile communication device communicatively coupled to the data access network and a remote server connected to the internet may be accessed by a network performance boosting appliance via a Transport Layer Security (TLS) proxy integral or otherwise functionally associated with an internet gateway of the data access network. The TLS proxy may provide the network performance boosting appliance with information about content being exchanged during any specific communication session and/or aggregated information about multiple communications sessions. The performance boosting appliance may include a content caching manager, a data routing manager, and or any other network parameter manager suitable to boost network performance based on an understanding of the content being accessed through the network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a generalized network diagram of an exemplary data access network including several internet gateways with TLS proxy for providing traffic data to a network performance boosting appliance, in accordance with some embodiments of the present invention where performance boosting includes caching;

FIG. 1B is a generalized network diagram of an exemplary data access network including several internet gateways with TLS proxy for providing traffic data to a network performance boosting appliance, in accordance with some embodiments of the present invention wherein performance boosting includes network traffic analytics and routing optimization;

FIG. 2 is a data flow diagram illustrating an exemplary data flow between a data client application running on a device communicatively coupled to a data access network, according to some embodiments, and to a remote data server through an internet gateway with TLS proxy such that a network boosting appliance for a data access network may gain access to TLS encrypted communication data transported across the data access network;

FIG. 3 is a flowchart including exemplary steps executed by a network performance boosting appliance, in accordance with some embodiments of the present invention; and

FIG. 4 is a block diagram of an exemplary cellular data access network arranged and operated in accordance with an embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

According to embodiments of the present invention, there may be provided a Transport Layer Security (“TLS”) Proxy enabled Gateway (“GW”) functionally associated with a data access network and located between a data client device communicatively coupled to an access node of the data access network and a remote server communicatively coupled to the internet. The TLS Proxy enabled GW may be a transparent TLS&TCP Proxy towards the client device and nontransparent, or partially transparent, TLS&TCP Proxy towards the remote server. One or more issues in managing and/or boosting performance of the data access network, caused by the transport of TLS communication between network client devices and servers located in the Internet, may be mitigated and/or solved by utilizing a TLS proxy functionally associated with a network performance boosting appliance as disclosed herein.

The present invention includes methods, circuits, devices, systems and functionally associated computer executable code for managing a data access network. According to some embodiments, encrypted data exchanged between a data client application running on a mobile communication device communicatively coupled to the data access network and a remote server connected to the internet may be accessed by a network performance boosting appliance via a Transport Layer Security (TLS) proxy integral or otherwise functionally associated with an internet gateway of the data access network. The TLS proxy may provide the network performance boosting appliance with information about content being exchanged during any specific communication session and/or aggregated information about multiple communications sessions. The performance boosting appliance may include a content caching manager, a data routing manager, and or any other network parameter manager suitable to boost network performance based on an understanding of the content being accessed through the network.

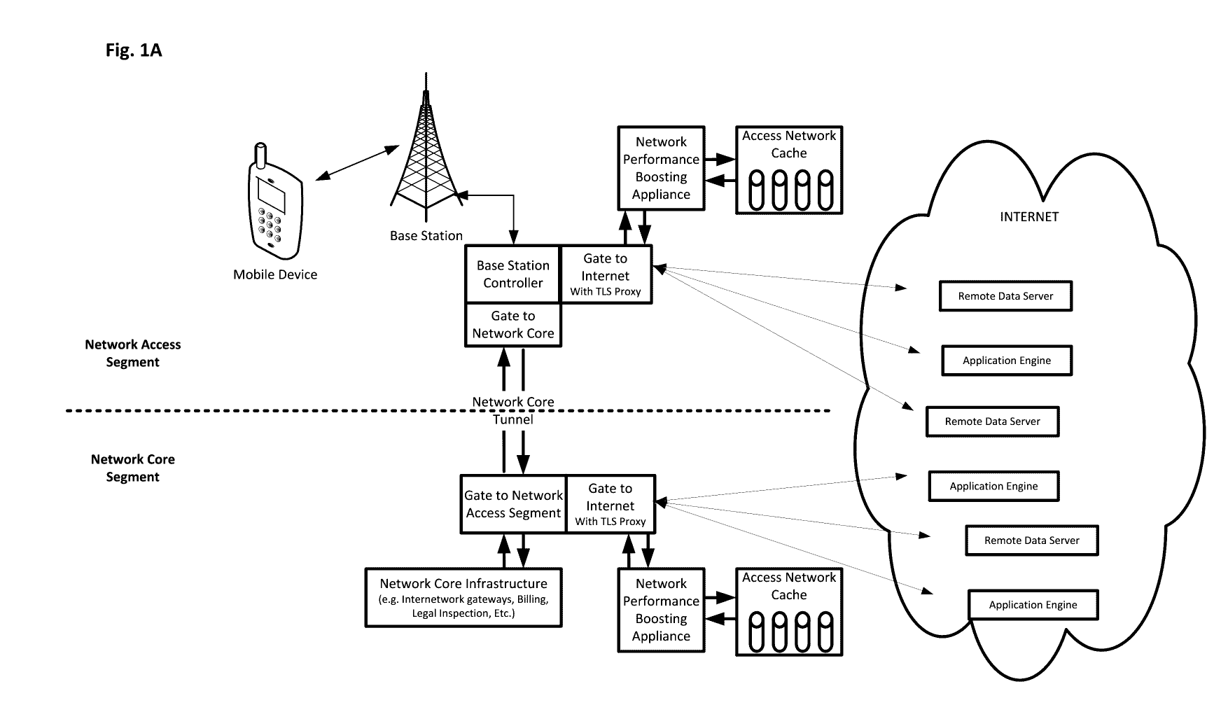

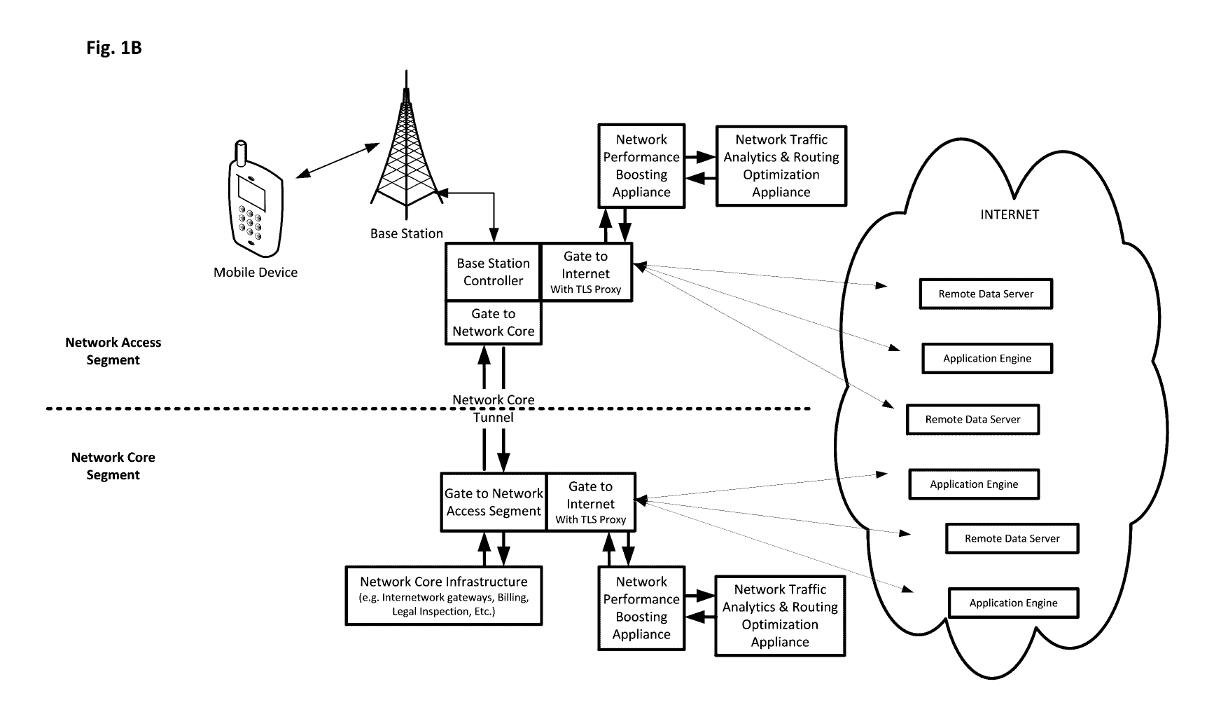

FIG. 1A is a generalized network diagram of an exemplary data access network including several internet gateways with TLS proxy for providing traffic data to a network performance boosting appliance, in accordance with some embodiments of the present invention where performance boosting includes caching. FIG. 1B is a generalized network diagram of an exemplary data access network including several internet gateways with TLS proxy for providing traffic data to a network performance boosting appliance, in accordance with some embodiments of the present invention wherein performance boosting includes network traffic analytics and routing optimization. In these figures, there are shown exemplary data access networks including a Internet gateways with TLS proxy located at the network core and near an access node (e.g. base station) for notifying respective network performance boosting appliances of the initiation of an encrypted communication sessions. The TLS proxies may also receive instructions for accessing, decrypting, and/or relaying back to the network performance boosting appliance, data from within the encrypted communication sessions traversing gateways.

The network performance boosting appliance, as shown in FIG. 1A, may include, be integrated into, and/or be functionally associated with a network caching system including one or more cache banks, or network access zone specific cache banks, and respective cache bank manager(s). The network performance boosting appliance may compare decrypted payload data of the initiated communication session data against data in respective cache bank(s), if the comparison is successful and data of the communication session is found to be locally cached, the network performance boosting appliance may initiate a switch over to cached data and start routing cached data to client in an encrypted format as if coming from the remote server shown. Alternatively, if the comparison is unsuccessful and data of the communication session is not found to be locally cached, the network performance boosting appliance may decide whether to cache the communication session data (e.g. based on demand history for the communication session data) and may store the data to respective cache bank(s) for future client use.

The network performance boosting appliance, as shown in FIG. 1B, may include, be integrated into, and/or be functionally associated with a network data routing systems and/or access (parental) control systems.

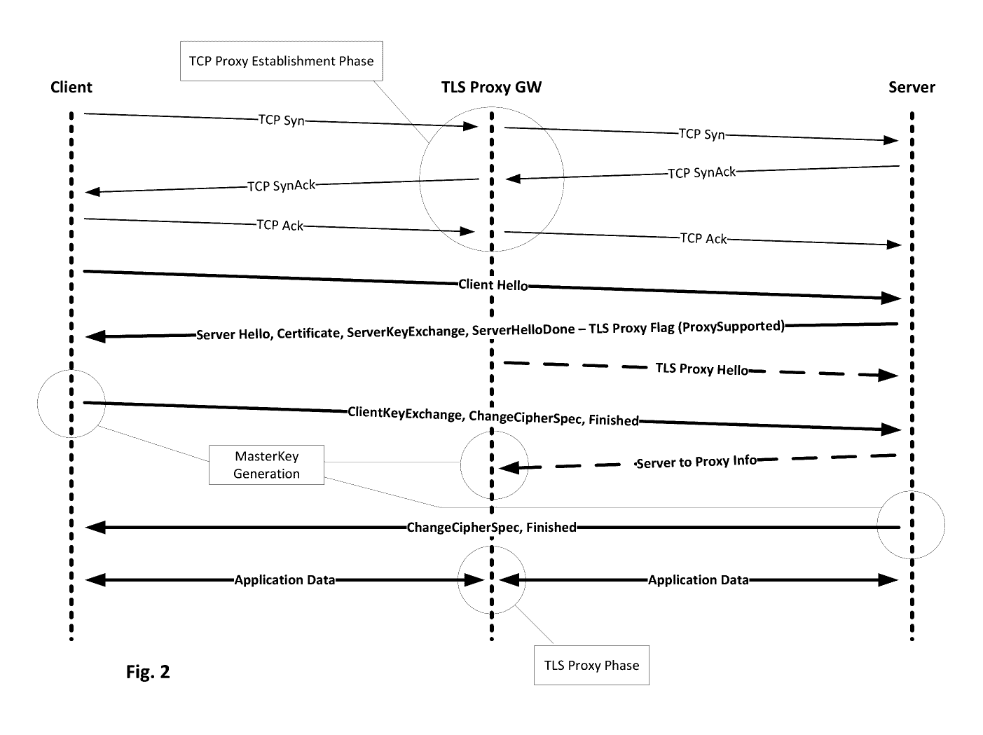

In FIG. 2 there is a shown a data flow diagram illustrating an exemplary data signal flow between a data client application running on a device communicatively coupled to a data access network, according to some embodiments, and to a remote data server through an internet gateway with TLS proxy; in the figure, TCP proxy establishment phase messages are shown in thin lines; standard TLS protocol handshake messages are shown in thick lines; and additional messages between the TLS proxy and the remote server, to allow the TLS proxy to decrypt and then re-encrypt the application data exchanged between the client and the server, are shown in thick broken lines.

According to some embodiments, the TLS Proxy may include a Transparent TCP Proxy, using a Transparent TCP Proxy may allow the TLS Proxy to manipulate, insert, remove or inspect packets in a transparent way to all other network elements.

According to some embodiments, if the remote server supports a TLS Proxy it may add a flag to the server hello message indicating that TLS Proxy is supported.

According to some embodiments, messages exchanged between the TLS Proxy and the Server shown in FIG. 2 may include:

(i) A TLS Proxy Hello: a message which is sent from the TLS Proxy to the Server. The message may be sent: (1) Within the existing TCP flow which was created between the Client and the Server, thus enabling the server to detect this message on its side and extract it from the standard TLS flow; and/or (2) On a dedicated control link between the TLS Proxy and the remote server, and wherein the message includes information enabling the identification of the specific TLS flow that requires the involvement of the TLS Proxy.

According to some embodiments, the TLS Proxy Hello message may contain the following: (1) a description of the TLS client-server flow that will allow the server to allocate the flow; (2) a public encryption key of the TLS Proxy, wherein the public key would be the public paired key of a private decryption key which is kept by the TLS Proxy, and wherein the selected encryption algorithm would be the same as already pre-negotiated between the client and the server during the TLS handshake between the client and the server; and/or (3) a signed TLS Proxy hello message wherein the TLS Proxy sends a certificate that may be validated proving it is who it claims to be.

(ii) A Server to Proxy Info: a message(s) which is sent from the Server to the TLS Proxy. The message may be sent: (1) Within the existing TCP flow which was created between the Client and the Server, wherein sending the message in such a way may enable the server to detect this message on its side and extract it from the standard TLS flow; and/or (2) On a dedicated control link between the TLS Proxy and the remote server, wherein the message may need to include information enabling identification of the specific TLS flow that requires the involvement of the TLS Proxy

According to some embodiments, the Server to Proxy Info message(s) may contain the following: (1) a Description of the TLS client-server flow, that may allow the TLS Proxy to allocate the flow; (2) a PreMaster key of the TLS flow and Client and Server random number; and/or (3) The Server to Proxy Info message may be encrypted by the server using the TLS Proxy public key

According to some embodiments, once the TLS Proxy receives the Server to Proxy info message it may generate the MasterKey of the specific TLS session and will be able to decrypt and later re-encrypt the application data.

According to some embodiments, under the TLS protocol there may be cases of short TLS handshake between the Client and Server, for example, in the case of reestablishment of a previous TLS flow(s) or a duplication of a TLS flow. The same method show in FIG. 1 may be used in this short TLS handshake to send The PreMaster key of the TLS flow and Client and Server random numbers of the new TLS flow.

The above disclosed system and methods may give the server application full control over which TLS flows the PreMaster key of the TLS flow and Client and Server random number, and will be shared by the Server with the TLS Proxy.

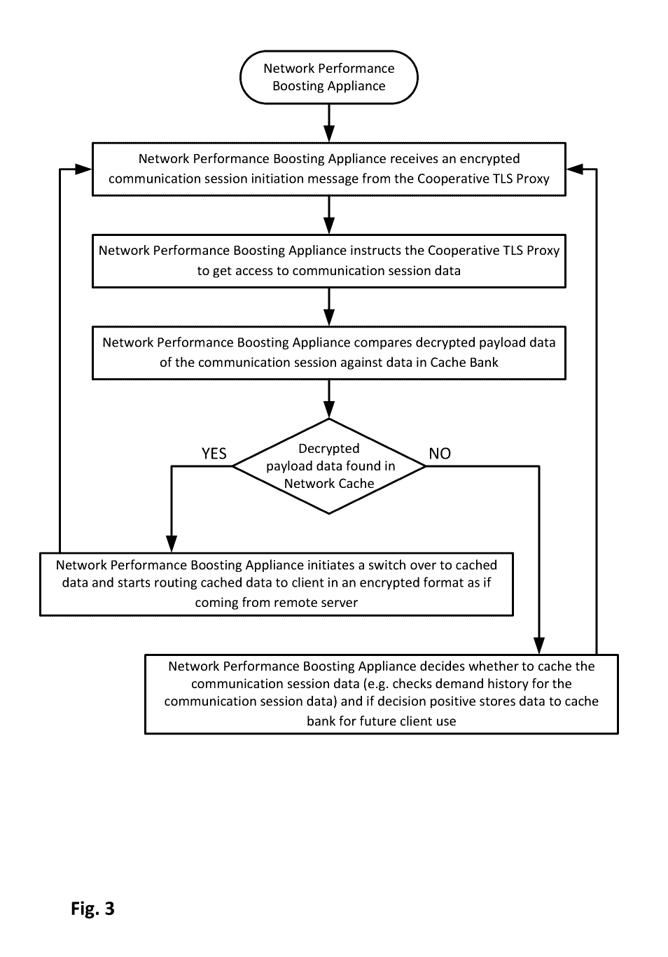

Turning now to FIG. 3, there is shown a flowchart including exemplary steps executed by a network performance boosting appliance, in accordance with some embodiments of the present invention, wherein the exemplary executed steps shown, includes: (1) the Network Performance Boosting Appliance receiving an encrypted communication session initiation message from the Cooperative TLS Proxy; (2) the Network Performance Boosting Appliance instructs the Cooperative TLS Proxy to get access to communication session data; (3) the Network Performance Boosting Appliance compares decrypted payload data of the communication session data against data in Cache Bank; if the decrypted payload data is found in the Cache Bank (4) the Network Performance Boosting Appliance initiates a switch over to cached data and starts routing cached data to client in an encrypted format as if coming from the remote server, alternatively, if the decrypted payload data is not found in the Cache Bank, (4′) the Network Performance Boosting Appliance decides whether to cache the communication session data (e.g. checks demand history for the communication session data) and if decision positive stores data to cache bank for future client use.

The Network Performance Boosting Appliance then continues ‘listening’ for receipt of further encrypted communication session initiation message(s) from the Cooperative TLS Proxy.

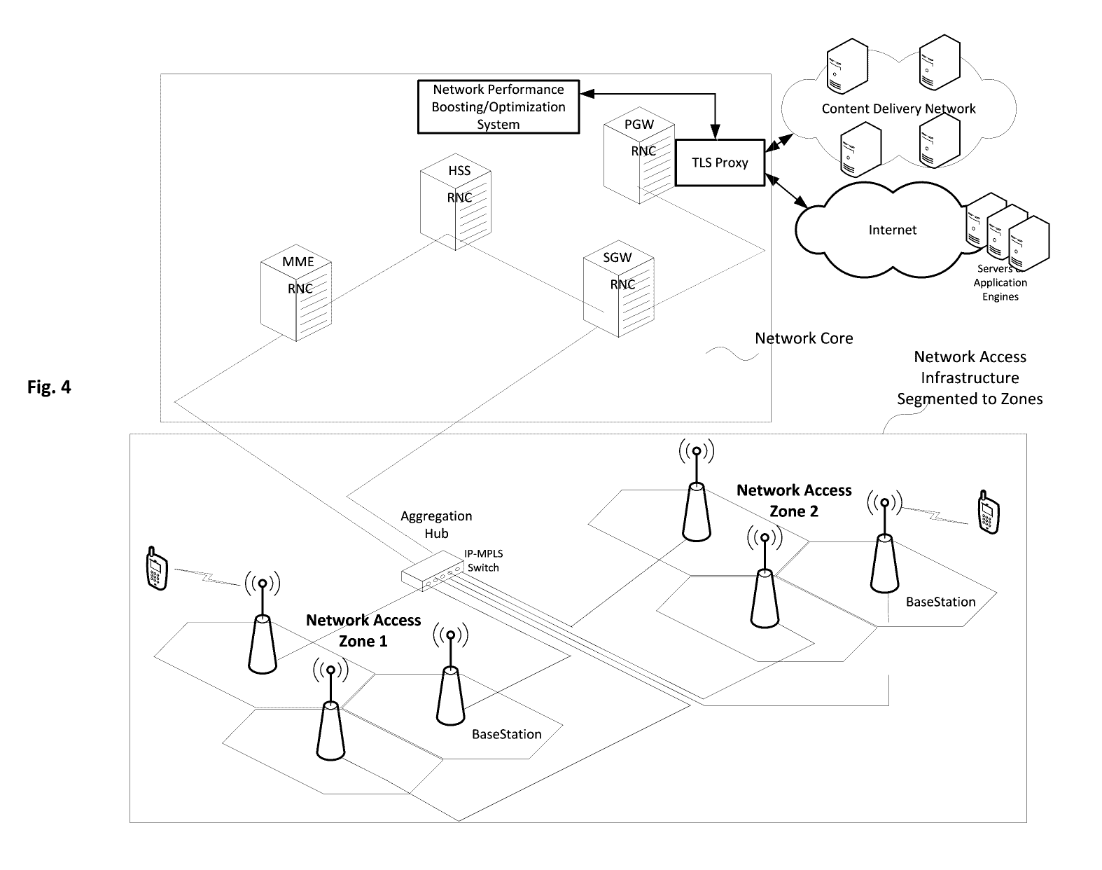

Turning now to FIG. 4, there is shown a block diagram of an exemplary cellular/wireless access network arranged and operated in accordance with embodiments of the present inventions where the performance boosting appliance is connected to Internet Gateway with TLS proxy located at the network core.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A data access network comprising:
one or more data client access nodes;
an internet gateway including a TLS proxy; and
network performance boosting appliance to receive data extracted from encrypted communication sessions traversing said gateway and boosting performance of said data access network.

2. The network according to claim 1, wherein performance boosting includes caching.

3. The network according to claim 1, wherein performance boosting includes injecting cached data into a communication session.

4. The network according to claim 1, wherein performance boosting includes adjusting data routing through said network.

5. The network according to claim 1, wherein performance boosting includes adjusting access control policies on said network.
